(19) United States
(12) Patent Application Publication
(10) Pub. No.: US 2012/0136631 A1
(43) Pub. Date: May 31, 2012

(54) SUBORDINATE AND MASTER SENSOR NODES

(76) Inventors: Alexandre Bratkovski, Mountain View, CA (US); Marco Fiorentino, Mountain View, CA (US); Raymond Beausoleil, Redmond, WA (US)

(21) Appl. No.: 13/386,714

(22) PCT Filed: Jan. 29, 2010
(86) PCT No.: PCT/US10/22501

§ 371 Date: Jan. 24, 2012

(51) Int. Cl. G06F 15/00

(52) U.S. Cl. 702/188

(57) ABSTRACT

Apparatus and systems are provided for data signaling between a centralized transceiver and a plurality of sensor nodes. Subordinate sensor nodes transmit data corresponding to sensed physical variables to a master node within a group. The master node within the group transmits the data on to a data acquisition transceiver. Data communications are performed by free-space signaling. Large areas can be monitored by a vast array of such sensors, organized as plural neighborhoods, without the need for wiring, optical fibers or other tangible interconnections.

### CROSS-REFERENCE TO RELATED APPLICATION

This application is related to co-pending application Ser. No. 13/386,364, titled “Sensor Nodes with Free-Space Signaling”, naming Alexandre M. Bratkovski and R. Stanley Williams as co-inventors, filed on the same date as the instant application, and which is hereby incorporated by reference.

### BACKGROUND

Large arrays of sensors are used in myriad endeavors such as oil field monitoring, seismic investigation, hydrology and others. In an illustrative scenario, many individual sensor units—upwards of a million or more—are distributed over an area of interest such as an oil or natural gas field. Various physical variables such as seismic waves, geomagnetic flux, sonar echoes and other parameters can be sensed by way of such an array.

However, known technology is dependent upon various wiring and cabling schemes in order to provide operating energy to and receive data from the numerous sora. Considerable cost, labor and mater Is are required to install and maintain interconnecting wiring between sensors and a data acquisition hub, The present teachings address the foregoing concerns.

### BRIEF DESCRIPTION OF THE DRAWINGS

The present embodiments will now be described, by way of example, with reference to the accompanying drawings, in which:

FIG. 1 depicts a perspective diagrammatic view of a system according to one embodiment;

FIG. 2 depicts an elevation view of a system according to another embodiment;

FIG. 3 depicts a block diagram of a device according to one embodiment;

FIG. 4 depicts a flow diagram of a method according to one embodiment;

FIG. 5 depicts a flow diagram of a method according to another embodiment.

### DETAILED DESCRIPTION

Introduction

Means and methods are provided for sensing physical variables over a large field deployment and for conveying corresponding data to an acquisition system. Subordinate sensor nodes transmit data corresponding to sensed physical variables to a master node within a group or neighborhood. The master node can also operate to sense physical variables at its respective location. The master node within the group transmits the data on to a data acquisition transceiver. Data communications are performed by way of free-space signaling. Large areas can be monitored by a vast array of such sensor, organized as plural neighborhoods, without the need for wiring, optical fibers or other tangible interconnections.

In one embodiment, a system includes one or more subordinate sensor nodes that are configured to sense one or more physical variables. The one or more subordinate sensor nodes are further configured to transmit data corresponding to the one or more physical variables by way of free-space signaling. The system also includes a master node configured to receive the data from the one or more subordinate sensor nodes by way of the free-space signaling. The master node is also configured to transmit the data by way of the free-space signaling. The system further includes a data transceiver configured to receive the data from the master node by way of the free-space signaling.

In another embodiment, a method includes sensing one or more physical variables using one or more subordinate sensor nodes. The method also includes receiving data corresponding to the one or nore physical variables from the subordinate sensor nodes at a master node. The receiving is done by way of free-space signaling. The method further includes transmitting the data from the master node to a data acquisition transceiver using the free-space signaling.

First Illustrative System

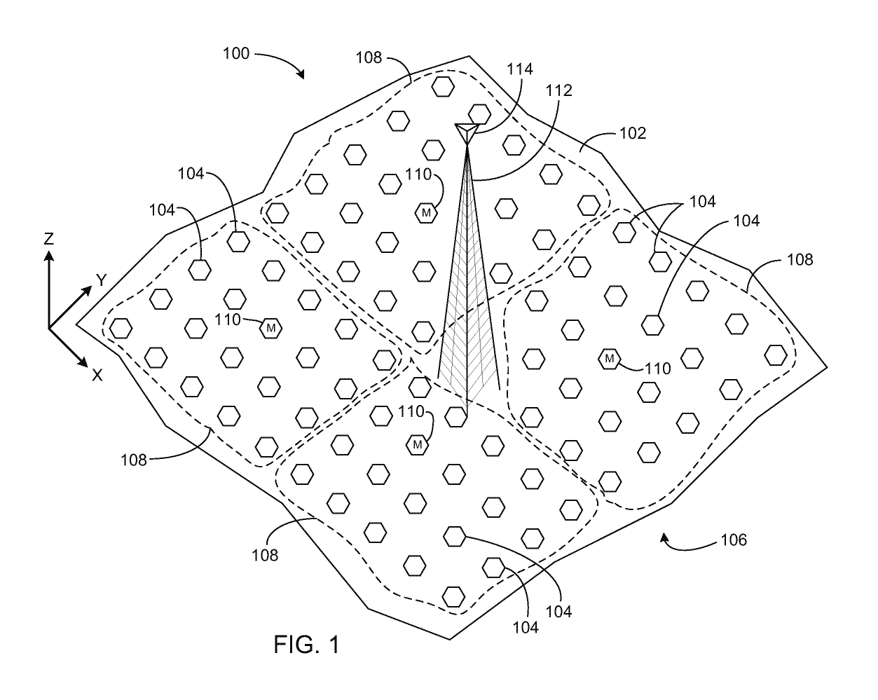

Reference is now made to FIG. 1, which depicts a perspective view of a system 100 according to the present teachings. The system 100 is illustrative and non-limiting with respect to the present teachings. Thus, other embodiments can be configured and/or used in accordance with the present teachings, including respectively varying characteristics and elements.

The system 100 operates within an environment including a ground surface area 102. For purposes of understanding, the surface area 102 is defined by X-and-Y dimensions and is assumed to be substantially flat (planar). However, the present teachings contemplate other surface areas having various topologies and features.

The system 100 also includes a plurality of individual sensor nodes (sensors) 104. Each of the sensors 104 is also referred to as a subordinate (or slave) sensor node 104. Each of the individual sensors 104 is configured to derive its own operating power from one or more renewable sources by way of appropriate transducers. Additionally, each sensor 104 is configured to transmit data corresponding to one or more sensed physical variables by way of free-space signaling. Further elaboration of such sensors according to the present teachings is provided hereinafter, The plurality of subordinate sensor nodes 104 are distributed over the surface area 102 such that an array or mesh 106 is defined.

The subordinate sensor nodes 104 are further arranged into respective groupings or “neighborhoods” 108. As depicted, four such groupings 108 are shown. However, the sensors 104 can be arranged (or designated) so that any suitable number of groupings 108 is defined. Each neighborhood 108 can be inclusive of any suitable number of subordinate sensor nodes 104 upwards of one-thousand (or more). Other subordinate sensor node 104 counts per neighborhood 108 can also be used.

The system 100 further includes a number of master control nodes (master nodes) 110. Each master node 110 is configured to bi-directionally communicate with the respect subordinate nodes 104 by way of free-space signaling. It is noted that each neighborhood 108 includes a single master (control) node 110 with which the associated subordinate sensor nodes 104 communicate by free-space signaling.

It is further noted that each master node 110 is generally centrally located within the neighborhood 108 in which it operates, with the associated subordinate sensor nodes 104 distributed there about. One or more (or all) of the master nodes 110 can optionally be configured to transmit data corresponding to one or more physical variables sensed by that master node 110. Thus, the master nodes 110 are also referred to herein as master sensor nodes 110 for purposes of simplicity.

The system 100 further includes a tower 112 located generally within the central of the ground surface area 102. The tower 112 extends away from the surface area 102 in a “Z” direction as indicated—that is, normal to the surface area 102. The tower 112 supports a signaling element 114. As depicted, the signaling element 114 is defined by a number of corner-cube reflectors configured to receive optical free-space signals from the master nodes 110. For non-limiting example, the signaling element 114 can be configured to receive infra-red light wave data signals from the master nodes 110.

Other signaling elements 114 such as, for non-limiting example, antennae, phototransistors, photodiodes, etc., can be used in accordance with the free-space signaling schema of the system 100. The signaling element 114 is understood to be coupled in signal communication with a data acquisition apparatus such as a transceiver, computer, data storage, or other elements.

Typical normal operations of the system 100 are described in detail hereinafter. In general, and without limitation, the subordinate sensor nodes 104 and the master nodes 110 operate in an autonomous and independent manner, generating electrical power from solar energy, wind power, thermoelectric effects or other means. The subordinate sensor nodes 104 also sense one or more physical variables such as seismic waves, etc., and provide corresponding free-space data signal transmissions to their corresponding master node 110.

In turn, the master nodes 110 communicate this physical variable-data to the signaling element 114 atop the tower 112. In this way, the array 106 of subordinate sensors 104 and master nodes 110 can monitor a vast area 102 without need for interconnecting electrical wiring, fiber optic signal cabling, or other similar resources.

Second Illustrative System

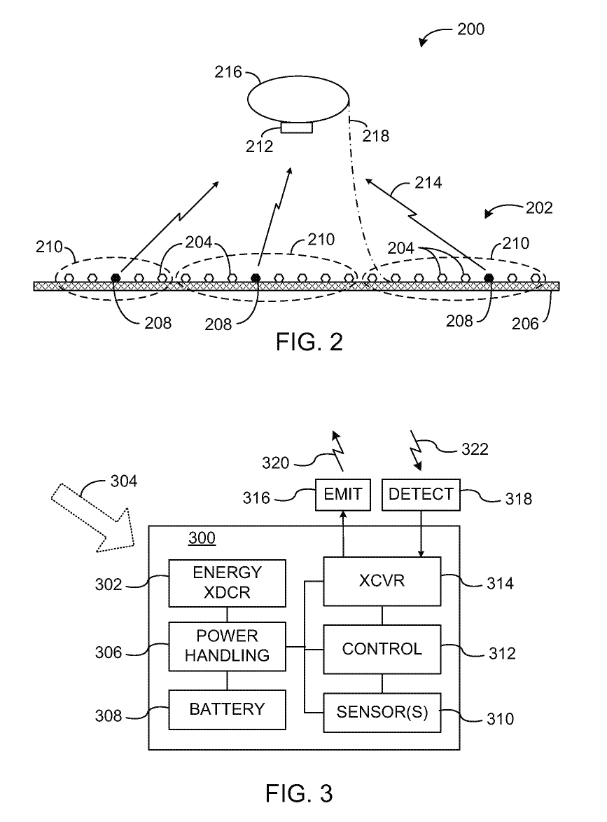

Attention is now directed to FIG. 2, which depicts an elevation view of a system 200 according to an embodiment of the present teachings. The system 200 is illustrative and non-limiting with respect to the present teachings. Thus, other systems can be configured and/or used in accordance with the present teachings.

The system 200 includes an array 202 of plural subordinate sensor nodes (sensors) 204. The subordinate sensor nodes 204 are distributed over a supporting surface area 206. The sensors 204 are configured to derive electrical energy from one or more renewable sources. The sensors 204 are also configured to sense one or more physical variables and to transmit data corresponding to those sensed variable by way of free-space signals.

The system 200 also includes a number of master (control) nodes 208. As depicted, three master nodes 208 are shown. Howeve the system 200 can be defined and configured such that any suitable number of master nodes 208 is provided. The subordinate sensor nodes 204 and master nodes 208 are arranged so as to define respective groupings (neighborhoods) 210. Each master node 208 receives data corresponding to sensed physical variables from the subordinate sensor nodes 204 within that neighborhood 210. The master nodes 208 then communicate that data to a data transceiver 212 by way of free-space signaling 214.

The system 200 also includes a lighter-than-air craft 216. The lighter-than-air craft 216 can be defined by a hydrogen- or helium-filled balloon or blimp, or some other suitable means. The lighter-than-air craft 216 is secured in place over the surface area 206 by one or more guy lines 218.

The system 200 includes a data transceiver (or data acquisition device) 212 as introduced above that is supported by the lighter-than-air craft 216. The data transceiver 212 is configured to transmit query (or interrogation) signals to the master nodes 208. The data transceiver 212 is further configured to receive free-space signals 212 from the master nodes 208. Such signals 214 are suitably modulated to convey data from the master nodes 208,

In this way, the data transceiver 212 can request and receive physical variable data from the master nodes 208. In turn, the master nodes 208 can transmit a data query (or interrogation) signal to the subordinate sensor nodes 204 within the corresponding group 210. Physical variable data is thus provided from the subordinate sensor nodes 204 to the respective master nodes 208, and from the master nodes 208 on to the data transceiver 212.

Additionally, the array 202 can be distributed over a relatively vast area 206 (i.e,, acres, square kilometers, etc.) without interconnecting wires, cables, etc. Free-space signals provide communication between very large numbers of subordinate sensors 204 and associated master nodes 208. The system 200 further operates by virtue of the airborne location of the data transceiver 212, In turn, the data transceiver 212 can be configured to record the received data, or relay the data as a stream or packets to another airborne or ground-based telemetry station (not show).

First Illustrative Device

Attention is now directed to FIG. 3, which depicts block diagram of a device 300 according to the present teachings. The device 300 is illustrative and non-limiting in nature. Other devices can be defined, configured and used in accordance with the present teachings. The device 300 can be operated, or suitably equipped and configured to operate, as either a subordinate sensor node (e.g., 204, etc.) or as a master node (e.g., 208, etc.). Thus, the device 300 is a general and illustrative representation of devices contemplated by the present teachings that are variously configurable so as to perform in accordance with their respective ranges of functions.

The device 300 includes an energy transducer 302. The transducer 302 is configured to generate, or derive, electrical energy directly from a physical stimulus input 304. The energy transducer 302 can be defined by one or more photovoltaic cells, wind-power generators, thermoelectric cells, thermopiles, etc. Other suitable energy transducers 302 can also be used, Accordingly, the physical stimulus input 304 can be sunlight, wind, thermal flux due to temperature differences, etc., respectively.

The device 300 also includes power handling 306. Power handling 306 can be defined by or include any suitable circuitry or resources configured to receive electrical energy from the energy transducer 302 and to condition or regulate at least one parameter of that energy. For non-limiting example, the power handling 306 can be configured to provide a regulated direct-current (DC) voltage output in response to varying electrical energy potential received from the energy transducer 302.

As such, the power handling 306 can include digital or analog circuitry, a microprocessor or microcontroller, a state machine, etc. As depicted, the power handling 306 is configured to provide a regulated DC voltage output and to store electrical energy within a battery 308. In turn, the battery 308 can be defined by any suitable rechargeable storage cell or array such as a nickel-cadmium (NiCad) battery, a lithium ion (Li-ion) battery, etc. Power tored within the battery 308 can be drawn upon by the power handling 306 during times of insufficient physical input 304. For non-limiting example, energy can be drawn from the battery 308 and used during night-time operations within a solar powered embodiment of device 300.

The device 300 further includes one or f yore sensors 310. The sensor(s) 310 can be defined by any suitable sensor or sensors (detectors, or transducers) configured to sense corresponding physical variables and to provide calibrated signals. Non-limiting examples of such sensor(s) 310 include acoustic microphones, seismic cors, thermometers, Magnetic flux detectors, etc. Other suitable sensor types can also be used. The one or more sensors 310 receive operating-level electrical energy as needed from the power handling 306.

The device 300 also includes a controller 312. The controller 312 is configured to control various normal operations of the device 300. The controller 312 can be defined, at least in part, by a microprocessor, microcontroller, state machine, electronic circuitry, etc. The controller 312 can also include computer-readable storage media (e.g., memory, non-volatile data storage, etc.) The controller 312 can include or be defined by other resources, as well. The controller 312 receives operating power from the power handling 306.

The controller 312 is configured to receive signals from the sensors 310 and format those signals as needed into digital data for transmission away from the device 300. The controller 312 can also store digital data representing the sensed physical variables for later retrieval and transmission away from the device 300.

Additionally, the controller 312 can be configured to include, or designated by, an identifier such as a number or code sequence, etc. The controller 312 can be further configured to communicate this identifier to other entities in response to a query, or to include the identifier in some or all data communication transmissions. In this way, unique identity information corresponding to field location or other parameters for each device 300 can be provided. Furthermore, the controller 312 can be configured so that the device 300 operates as either a subordinate sensor node or as a master control node.

The sensor 300 further includes a transceiver 314. In one embodiment, the transceiver 314 is an optical transceiver. In another embodiment, the transceiver 314 is a broadband transceiver. For purposes of non-limiting illustration, it is assumed that the transceiver 314 is an optical transceiver 314. As such, the optical transceiver 314 is configured to bidirectionally comcommunicate data between the controller 312 and an entity or entities (e.g., master node 208, etc.) external to the device 300 by way of free-space optical signaling 320 and 322. Toward that end, the optical transceiver 314 includes an optical signal emitter 316 and an optical signal detector 318. The emitter 316 can be defined by one or more infra-red, visible or ultra-violet light-emitting diodes (LEDs), a laser, or other controllable light source. The detector 316 can be defined by one or more phototransistors, cadmium-sulfide cells, etc. Other suitable emitters 316 or detectors 318 can also be used.

In another embodiment (not shown), the optical transceiver 314 is omitted and replaced by a radio transceiver device configured to communicate data by way of radio signals. Other free-space signaling devices or schemes can also be used.

Normal, illustrative operation of the device 300, configured to operate as a subordinate sensor node, is as follows: Physical stimulus 304 (e.g., solar energy, etc.) drives the energy transducer 302 to produce electrical energy. This electrical energy is coupled to power handling 306, which derives a regulated DC output voltage and stores some of the electrical energy within battery (or batteries) 308.

Meanwhile, the sensor(s) 310 sense one or f yore physical variables such as sonar echoes, etc., and provide corresponding signals to the controller 312. The controller 312 formats the signal or signals are respective digital data and provides that data to the optical transceiver 314. In turn, the optical transceiver 314 controls operation of the emitter 316 such that modulated free-space optical signals 320 corresponding to the digital data are transmitted from device 300. These transmissions can include an identifier for the device 300.

In another illustrative operating scenario, signals from the sensors) 310 are stored as digital data by the controller 312. A free-space interrogation signal 322 is then received by way of the detector 318 and optical transceiver 314. The controller 312 responds to this interrogation (or query) by retrieving stored digital data from media (memory) and transmitting that data by way of the optical transceiver 314.

First Illustrative Method

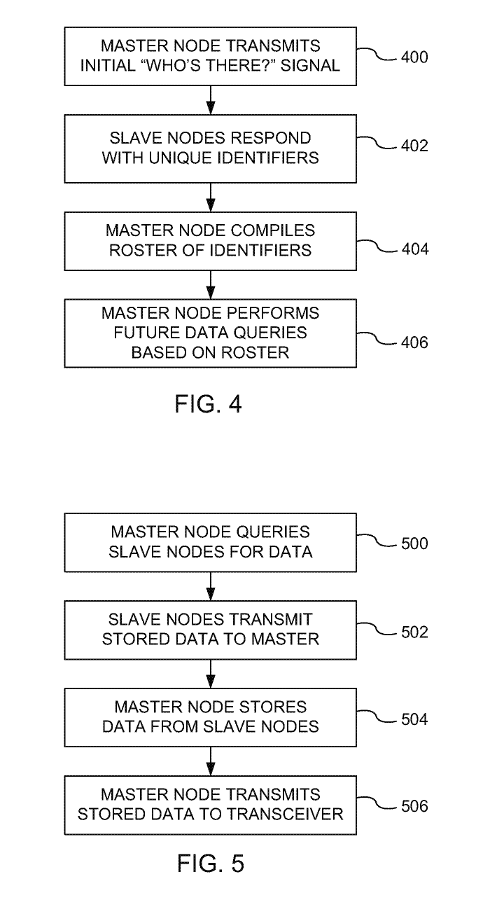

FIG. 4 is a flow diagram depicting a method according to one embodiment of the present teachings. The method of FIG. 4 includes particular operations and order of execution. However, other methods including other operations, omitting one or more of the depicted operations, and/or proceeding in other orders of execution can also be used according to the present teachings, Thus, the method of FIG, 4 is illustrative and non-limiting in nature. Illustrative reference is also made to FIG. 2 in the interest of understanding the method of FIG. 4.

At 400, a master node transmits a general identification inquiry or“who's there?” signal, For purposes of non-limiting illustration, it is assumed that a master node 208 transmits an identification request to surrounding subordinate sensor nodes 204. Such transmission is made by way of free-space signaling.

At 402, subordinate (slave) nodes receiving the inquiry respond by transmitting unique identifiers, For purposes of the on-going illustration, subordinate sensor nodes 204, receiving the inquiry at or above some minimum signal strength threshold level, respond by transmitting theft respective identifiers. Such identifier transmissions are performed by way of free-space signaling. The identifier transmissions can be made according to a random time-slot selection scheme, by way of distinct modulation techniques, etc.

At 404, the master node receives the identifiers and COf piles a corresponding roster. For purposes of the on-going illustration, the identifiers sent by respondent subordinate nodes 204 are received by the requesting master node 208. These identifiers are used to populate a roster, or list, of the subordinate sensor nodes 204 relatively proximate to the master node 204. The respondent subordinate sensor nodes 204 and corresponding master node 208 define a grouping or neighborhood 210, The master node 208 can transmit an acknowledgment of each received identifier, use a predetermined collision-avoidance or error-correction scheme, etc., in to order to ensure that all identifiers are properly received and recorded. The corresponding neighborhood can include any suitable number of subordinate sensor nodes.

At 406, the master node performs future data inquiries using the roster. For purposes of the on-going illustration, it is understood that the master node 208 sends inquires for physical variable data to the subordinate sensor nodes 204 that are included on the neighborhood roster. Such data inquires can be issued in accordance with any desirable timing scheme, triggered by predefined events or sensor inputs, issued in response to an inquiry from a centralized data transceiver (e.g., 212, etc.). Other schemes can also be used.

Second Illustrative Method

FIG. 5 is a flow diagram depicting a method according to another embodiment of the present teachings. The method of FIG. 5 includes particular operations and order of execution. However, other methods including other operations, omitting one or more of the depicted operations, and/or proceeding in other orders of execution can also be used according to the present teachings. Thus, the method of FIG. 5 is illustrative and non-limiting in nature. Illustrative reference is also made to FIG. 2 in the interest of understanding the method of FIG. 5.

At 500, a master node transmits a data query to subordinate (slave) sensor nodes associated there with. For purposes of non-limiting illustration, it is assumed that a master node 208 transmits a data request to the surrounding subordinate sensor nodes 204. Such request is made by way of free-space signaling, and is based upon an identifier roster. The data request (or requests) can be made in a sequential identifier order, in accordance with a predetermined collision-avoidance or error-correction scheme, etc.

At 502, subordinate (slave) nodes receiving the data inquiry respond by transmitting stored data. For purposes of the on-going illustration, subordinate sensor nodes 204 respond by retrieving stored physical variable data from storage media (e.g., memory, etc.). The retrieved data is then formatted as needed and transmitted to the requesting master node 208 by way of free-space signaling. These transmissions are also assumed to include respective identifiers.

At 504, the master node receives and stores the transmitted data from the slave sensor nodes. For purposes of the on-going illustration, the master node 208 receives the data, corresponding to sensed physical variables, and stores that data within on board storage media. Eventually, the master node 208 receives and stores all of the data provided by the subordinate sensor nodes in response to the request(s) issued at 500 above.

At 506, the master node transmits the stored physical variable data to a data acquisition transceiver. For purposes of the on-going illustration, it is assumed that the master node 208 responds to a data request from the transceiver 212 and transmits the most recently received data by way of free-space signaling 214.

In accordance with the present teachings, and without limitation, sensor nodes are defined and configured to sense one or more physical variables. Such physical variables are of interest in some field deployment scenario. The sensor nodes are also configured to communicate by way of free-space signals such as optical, radio, etc. Groupings or neighborhoods are manually designated or automatically determined such that numerous subordinate sensor nodes report their data to a master node therein. In turn, each master node reports data for that neighborhood to a centralized data acquisition system.

The sensor nodes and master nodes are further configured to derive their own operating power by way of photovoltaic, wind generation, or other renewable resources. In this way, each node (sensor or master) is configured to operate in an independent, self-powered manner and to function as an element within a large-scale array without need for hardwired connection to an electrical or signal communications network.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. A system, comprising:
one or more subordinate sensor nodes configured to sense one or more physical variables, the one or more subordinate sensor nodes further configured to transmit data corresponding to the one or more physical variables by way of free-space signaling;
a master node configured receive the data from the one or more subordinate sensor nodes by way of the free-space signaling, the master node further configured to transmit the data by way of the free-space signaling; and
a data transceiver configured to receive the data from the master node by way of the free-space signaling.

2. The system according to claim 1, the master node further configured to sense one or more physical variables.

3. The system according to claim 1, the master node further configured to store the data received from the one or more subordinate sensor nodes.

4. The system according to claim 1, at least one of the master node or the subordinate sensor nodes further configured to produce electrical energy by way of a photovoltaic transducer, a thermoelectric transducer, or a wind-power transducer.

5. The system according to claim 1, the data transceiver supported by way of a tower, or a lighter-than-air craft.

6. The system according to claim 1, the master node further configured to send an interrogation signal to the one or more subordinate sensor nodes by way of the free-space signaling.

7. The system according to claim 1, the data transceiver further configured to send an interrogation signal to the master node by way of the free-space signaling.

8. The system according to claim 1, the one or more subordinate sensor nodes further configured such that the free-space signaling Includes at least optical signals, or radio signals.

9. The system according to claim 1, the master node and the one or more subordinate sensor nodes distributed as an array over a predetermined area.

10. The system according to claim 1, the data transceiver coupled to computer-accessible storage media configured to store the data.

11. The system according to claim 1, each subordinate sensor node configured to operate without tangible signal coupling to the other subordinates sensor nodes or the master node.

12. A method, comprising:
sensing one or more physical variables using one or more subordinate sensor nodes;
receiving data corresponding to the one or more physical variables from the subordinate sensor nodes at a master node using free-space signaling; and
transmitting the data from the master node to a data acquisition transceiver using the free-space signaling.

13. The method according to claim 12 further comprising:
transmitting an identification query from the master node using the free-space signaling;
receiving an individual identifier from each of the subordinate sensor nodes at the master node using the free-space signaling; and
compiling a roster of the individual identifiers at the master node.

14. The method according to claim 12 further comprising receiving a data query from the data acquisition transceiver at the master node using the free-space signaling.

15. The method according to claim 12 further comprising transmitting a data query from the master node to at least one of the subordinate sensor nodes using the free-space signaling.
